(19) United States
(12) Patent Application Publication
(10) Pub. No.: US 2015/0215412 A1
(43) Pub. Date: Jul. 30, 2015

(54) SOCIAL NETWORK SERVICE QUEUING USING SALIENCE

(71) Applicant: Fujitsu Limited, Kawasaki-shi (JP)

(72) Inventors: David L. MARVIT, San Francisco, CA (US); Jeffrey UBOIS, Chicago, IL (US)

(73) Assignee: FUJITSU LIMITED, Kawasaki-shi (JP)

(21) Appl. No.: 14/165,360

(22) Filed: Jan. 27, 2014

(51) Int. Cl. H04L 29/08; G06F 3/0484; G06F 3/01

(52) U.S. Cl. CPC H04L 67/22; G06F 3/013; G06F 3/04842

(57) ABSTRACT

A method of using salience to send a content item to a social network service is provided. The method includes providing a content item to a user through a user interface and collecting physiological data of the user as the user interacts with the content item. The method also includes determining a salience score of the content item based at least in part on the physiological data. In the event the salience score is greater than a salience threshold, the method includes sending the content item to a social network service.

### FIELD

The embodiments discussed herein are related to social network service queuing using salience.

### BACKGROUND

The information age has ushered in the social network service age. People have more ways to stay interconnected than ever before. Social network services allow individuals to share content across a network in many different ways using Facebook®, Google+™, Twitter, Tumblr, Instagram, and Orkut, to name a few. Many other social network services are also available. Users may share photos, stories, posts, messages, videos, etc. with connections and/or friends throughout the world using these services.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of using salience to send content items to a social network service is provided. The method includes providing a content item to a user through a user interface and collecting the user's physiological response as the user is exposed to the content item. The method also includes determining a salience score of the content item based at least in part on the physiological data. In the event the salience score is greater than a salience threshold, the method includes sending the content item to a social network service.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example system for associating eye tracking data and physiological data with content in a document according to at least one embodiment described herein.

FIG. 2 is a block diagram of an example eye tracking subsystem according to at least one embodiment described herein.

FIG. 3 is a block diagram of an example electroencephalography (EEG) system according to at least one embodiment described herein.

FIG. 4 illustrates an example EEG headset with a plurality of EEG sensors according to at least one embodiment described herein.

FIG. 5 illustrates an example document that may be viewed by a user through a display according to at least one embodiment described herein.

FIG. 6 is a flowchart of an example process for sending content to a social network service based on a salience score according to at least one embodiment described herein.

FIG. 7 is a flowchart of an example process for queuing content prior to sending the content to a social network service according to at least one embodiment described herein.

### DESCRIPTION OF EMBODIMENTS

Social network services allow users to share or post any type of content with their friends and/or contacts. Often, however, it may be difficult for a user to determine what content to share using the social network service. The various embodiments described herein, among other things, may include systems and methods that automatically share content with a social network service based on a rule, behavior data, physiological data, and/or salience data.

The salience of an item is the state or quality by which it stands out relative to its neighbors. Generally speaking, salience detection may be an attentional mechanism that facilitates learning and survival by enabling organisms to focus their limited perceptual and cognitive resources on the most pertinent subset of the available sensory data. Salience may also indicate the state or quality of content relative to other content based on a user's subjective interests in the content. Salience in document organization may enable organization based on how pertinent the document is to the user and/or how interested the user is in content found within the document.

The focus of a user on content may be related to salience. Focus may include the amount of time the user spends viewing content relative to other content as well as the physiological or emotional response of the user to the content.

Salience and/or focus may be measured indirectly. For instance, the salience may be measured at least in part by using devices that relate to a user's physiological and/or emotional response to the content, for example, those devices described below. The salience and/or focus may relate to how much or how little the user cares about or is interested in what they are looking at. Such data, in conjunction with eye tracking data and/or keyword data, may suggest the relative importance or value of the content to the user. The focus may similarly be measured based in part on the user's physiological and/or emotional response and in part by the amount of time the user views the content using, for example, eye tracking data. A salience score may represent a numerical number that is a function of physiological data recorded from one or more physiological sensors and/or eye tracking data recorded from an eye tracking subsystem.

Embodiments of the present invention will be explained with reference to the accompanying drawings.

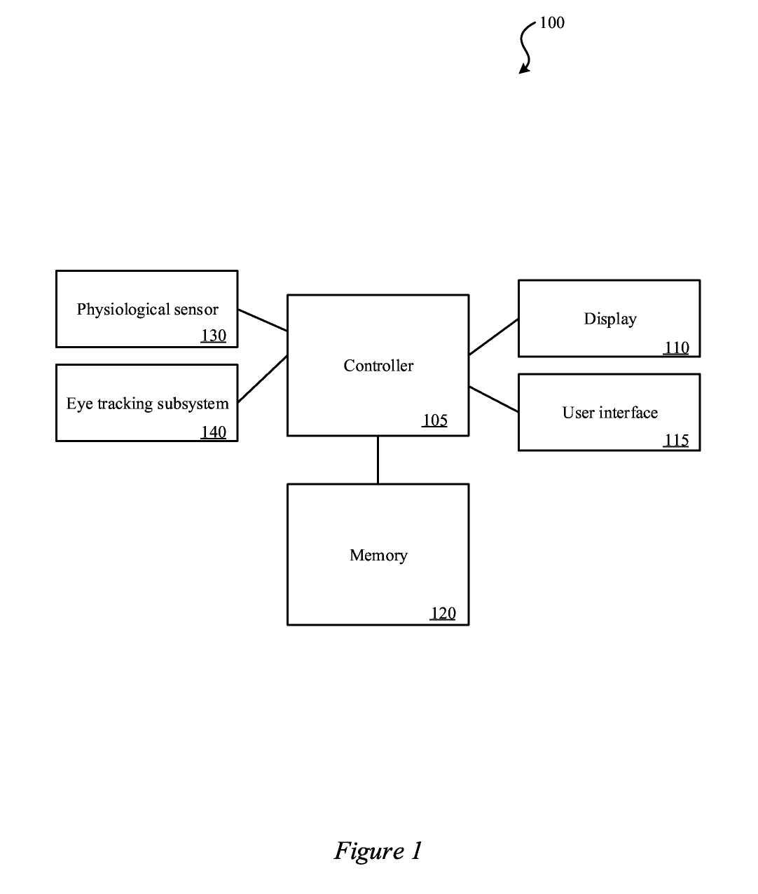

FIG. 1 is a block diagram of an example system 100 for associating eye tracking data and physiological data with content in a document in accordance with at least one embodiment described herein. The system 100 may include a controller 105, a display 110, a user interface 115, and a memory 120, which may, in at least one embodiment described herein, be part of a standalone or off-the-shelf computing system. The system 100 may include various other components without limitation. The system 100 may also include an eye tracking subsystem 140 and/or a physiological sensor 130. In at least one embodiment described herein, the physiological sensor 130 may record brain activity data, for example, using an EEG system. In at least one embodiment described herein, a physiological sensor other than an EEG system may be used.

In at least one embodiment described herein, the controller 105 may be electrically coupled with and control the operation of each component of the system 100. For instance, the controller 105 may execute a program that displays a document stored in the memory 120 on the display 110 and/or through speakers or another output device in response to input from a user through the user interface 115. The controller 105 may also receive input from the physiological sensor 130, and the eye tracking subsystem 140.

As described in more detail below, the controller 105 may execute a process that associates inputs from one or more of an EEG system, the eye tracking subsystem 140, and/or other physiological sensors 130 with content within a document displayed in the display 110 and may save such data in the memory 120. Such data may be converted and/or saved as salience and/or focus data (or scores) in the memory 120. The controller 105 may alternately or additionally execute or control the execution of one or more other processes described herein.

The physiological sensor 130 may include, for example, a device that performs functional magnetic resonance imaging (fMRI), positron emission tomography, magnetoencephalography, nuclear magnetic resonance spectroscopy, electrocorticography, single-photon emission computed tomography, near-infrared spectroscopy (NIRS), Galvanic Skin Response (GSR), Electrocardiograms (EKG), pupillary dilation, Electrooculography (EOG), facial emotion encoding, reaction times, and/or event-related optical signals. The physiological sensor 130 may also include a heart rate monitor, galvanic skin response (GSR) monitor, pupil dilation tracker, thermal monitor or respiration monitor.

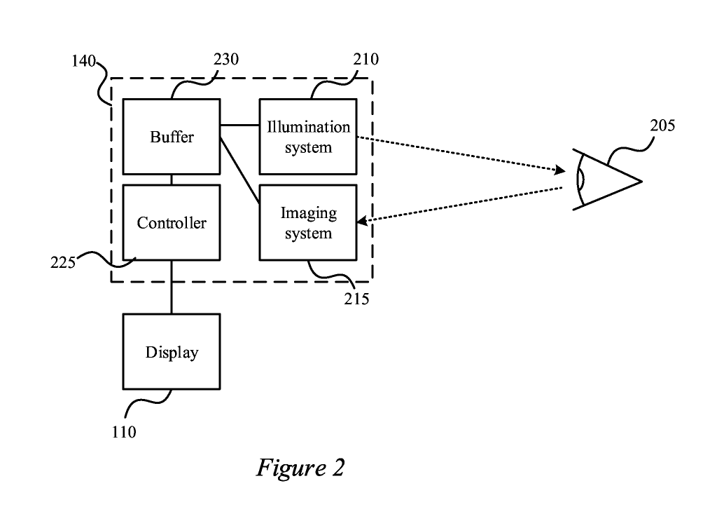

FIG. 2 is a block diagram of an example embodiment of the eye tracking subsystem 140 according to at least one embodiment described herein. The eye tracking subsystem 140 may measure the point of gaze (where one is looking) of the eye 205 and/or the motion of the eye 205 relative to the head. In at least one embodiment described herein, the eye tracking subsystem 140 may also be used in conjunction with the display 110 to track either the point of gaze or the motion of the eye 205 relative to information displayed on the display 110. The eye 205 in FIG. 2 may represent both eyes and eye tracking subsystem may perform the same function on one or both eyes.

The eye tracking subsystem 140 may include an illumination system 210, an imaging system 215, a buffer 230, and a controller 225. The controller 225 may control the operation and/or function of the buffer 230, the imaging system 215, and/or the illumination system 210. The controller 225 may be the same controller as the controller 105 or a separate controller. The illumination system 210 may include one or more light sources of any type that direct light, for example, infrared light, toward the eye 205. Light reflected from the eye 205 may be recorded by the imaging system 215 and stored in the buffer 230. The imaging system 215 may include one or more imagers of any type. The data recorded by the imaging system 215 and/or stored in the buffer 230 may be analyzed by the controller 225 to extract, for example, eye rotation data from changes in the reflection of light off the eye 205. In at least one embodiment described herein, corneal reflection (often called the first Purkinje image) and the center of the pupil may be tracked over time. In other embodiments, reflections from the front of the cornea (the first Purkinje image) and the back of the lens (often called the fourth Purkinje image) may be tracked over time. In other embodiments, features from inside the eye may be tracked such as, for example, the retinal blood vessels. In yet other embodiments, eye tracking techniques may use the first Purkinje image, the second Purkinje image, the third Purkinje image, and/or the fourth Purkinje image singularly or in any combination to track the eye. In at least one embodiment described herein, the controller 225 may be an external controller.

In at least one embodiment described herein, the eye tracking subsystem 140 may be coupled with the display 110. The eye tracking subsystem 140 may also analyze the data recorded by the imaging system 215 to determine the eye position relative to a document displayed on the display 110. In this way, the eye tracking subsystem 140 may determine the amount of time the eye viewed specific content items within a document on the display 110. In at least one embodiment described herein, the eye tracking subsystem 140 may be calibrated with the display 110 and/or the eye 205.

The eye tracking subsystem 140 may be calibrated in order to use viewing angle data to determine the portion (or content items) of a document viewed by a user over time. The eye tracking subsystem 140 may return view angle data that may be converted into locations on the display 110 that the user is viewing. This conversion may be performed using calibration data that associates viewing angle with positions on the display.

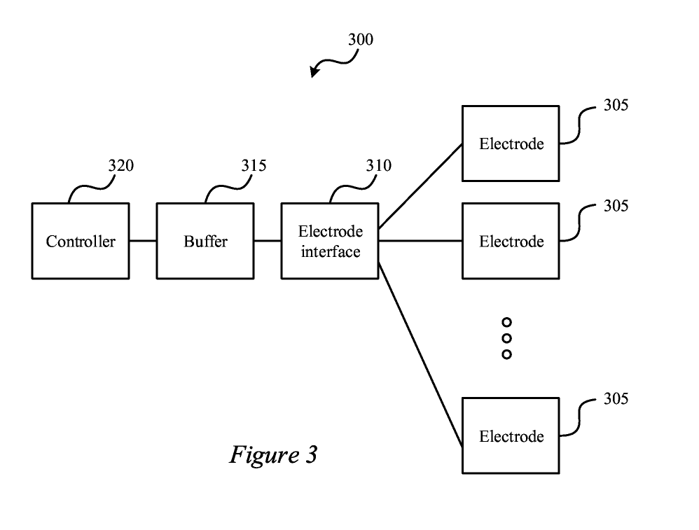

FIG. 3 is a block diagram of an example embodiment of an EEG system 300 according to at least one embodiment described herein. The EEG system 300 is one example of a physiological sensor 130 that may be used in various embodiments described herein. The EEG system 300 may measure voltage fluctuations resulting from ionic current flows within the neurons of the brain. Such information may be correlated with how focused and/or attentive the individual is when viewing a document or a portion of the document being viewed while EEG data is being collected. This information may be used to determine the focus and/or salience of the document or a portion of the document. The data collected from the EEG system 300 may include either or both the brain's spontaneous electrical activity or the spectral content of the activity. The spontaneous electrical activity may be recorded over a short period of time using multiple electrodes placed on or near the scalp. The spectral content of the activity may include the type of neural oscillations that may be observed in the EEG signals. While FIG. 3 depicts one type of EEG system, any type of system that measures brain activity may be used.

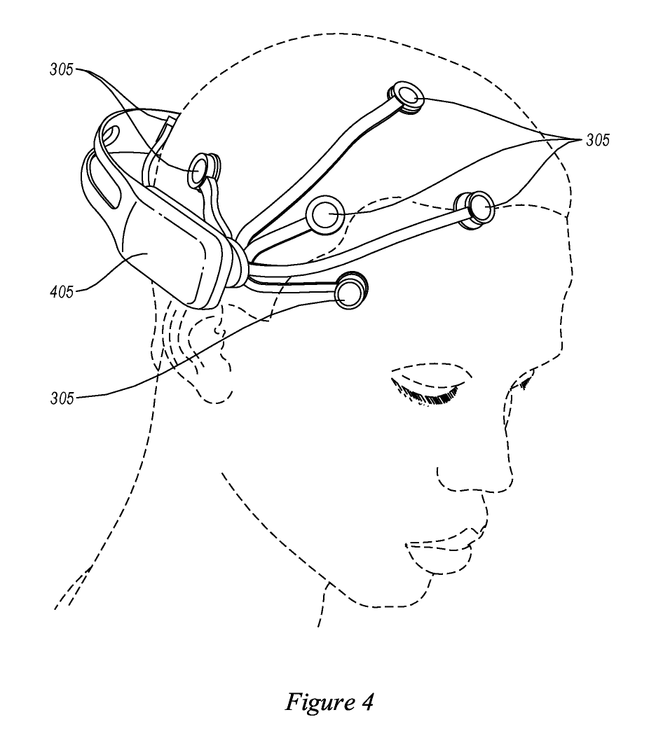

The EEG system 300 may include a plurality of electrodes 305 that are configured to be positioned on the scalp of a user. The electrodes 305 may be coupled with a headset, hat, or cap (see, for example, FIG. 4) that positions the electrodes on the scalp of a user when in use. The electrodes 305 may be saline electrodes, post electrodes, gel electrodes, etc. The electrodes 305 may be coupled with a headset, hat, or cap following any number of arranged patterns such as, for example, the pattern described by the international 10-20 system standard for the electrodes 305 placements.

The electrodes 305 may be electrically coupled with an electrode interface 310. The electrode interface 310 may include any number of components that condition the various electrode signals. For example, the electrode interface 310 may include one or more amplifiers, analog-to-digital converters, filters, etc. coupled with each electrode. The electrode interface 310 may be coupled with buffer 315, which stores the electrode data. The controller 320 may access the data and/or may control the operation and/or function of the electrode interface 310, the electrodes 305, and/or the buffer 315. The controller 320 may be a standalone controller or the controller 105.

The EEG data recorded by The EEG system 300 may include EEG rhythmic activity, which may be used to determine a user's salience when consuming content with a document. For example, theta band EEG signals (4-7 Hz) and/or alpha band EEG signals (8-12 Hz) may indicate a drowsy, idle, relaxed user, and result in a low salience score for the user while consuming the content. On the other hand, beta EEG signals (13-30 Hz) may indicate an alert, busy, active, thinking, and/or concentrating user, and result in a high salience score for the user while consuming the content.

FIG. 4 illustrates an example EEG headset 405 with a number of Electrodes 305 according to at least one embodiment described herein. The Electrodes 305 may be positioned on the scalp using the EEG headset 405. Any number of configurations of the Electrodes 305 on the EEG headset 405 may be used.

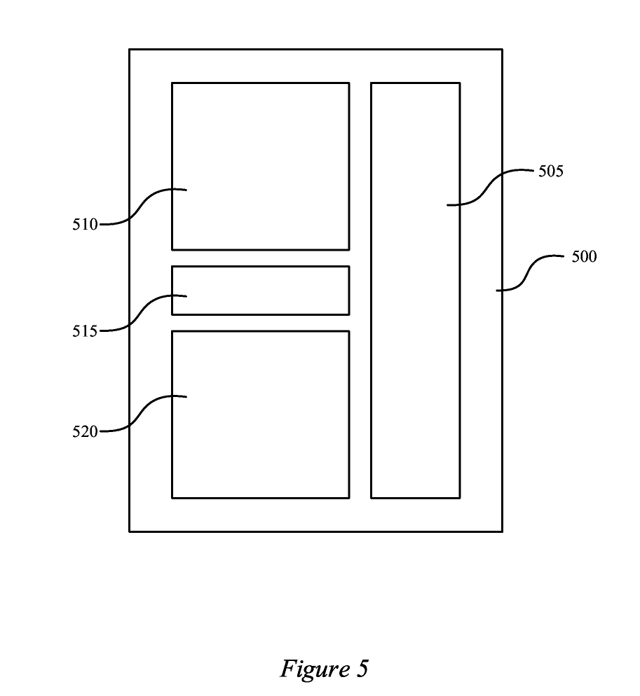

FIG. 5 illustrates an example document that may be consumed by a user through the display 110 and/or through speakers or another output device according to at least one embodiment described herein. In this example, the document 500 includes an advertisement 505, which may include text, animation, video, and/or images, a body of text 510, an image 515, and a video 520. Advertisement 505 and/or video 520 may be time-based content and may include audio. Various other content or content items may be included within documents 500.

The term “content item” refers to one of the advertisement 505, the text 510, the image 515, and the video 520; the term may also refer to other content that may be present in a document. The term “content item” may also refer to a single content item such as music, video, flash, text, a PowerPoint presentation, an animation, an HTML document, a podcast, a game, etc. Moreover, the term “content item” may also refer to a portion of a content item, for example, a paragraph in a document, a sentence in a paragraph, a phrase in a paragraph, a portion of an image, a portion of a video (e.g., a scene, a cut, or a shot), etc. Moreover, a content item may include sound, media or interactive material that may be provided to a user through a user interface that may include speakers, a keyboard, touch screen, gyroscopes, a mouse, heads-up display, instrumented “glasses”, and/or a hand held controller, etc. The document 500 shall be used to describe various embodiments described herein.

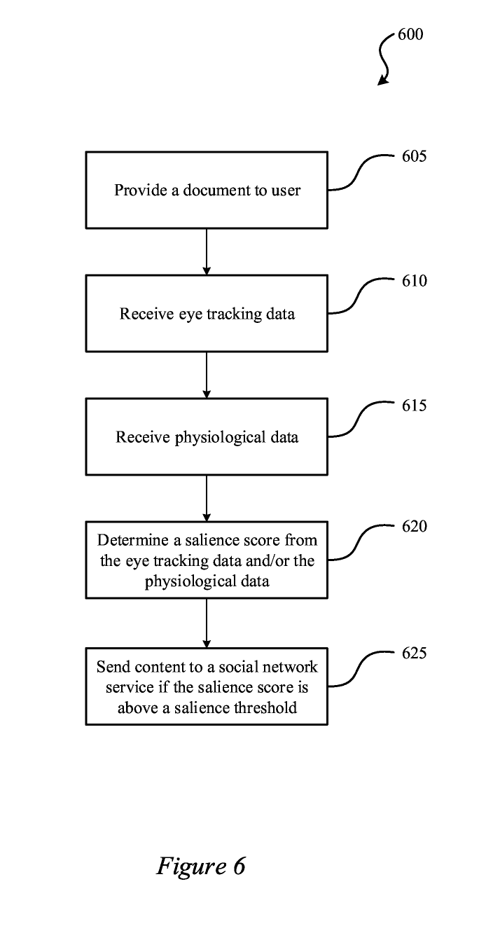

FIG. 6 is a flowchart of an example process 600 for sending content to a social network service based on a salience score according to at least one embodiment described herein. The process 600 may begin at block 605. The document 500 may be provided to a user, for example, through the display 110 and/or the user interface 115. At block 610, eye tracking data may be received from, for example, the eye tracking subsystem 140. Eye tracking data may include viewing angle data that includes a plurality of viewing angles of the user's eye over time as the user views portions of the content in the document 500. The viewing angle data may be used to determine which specific portions of the display the user was viewing at a given time. This determination may be made based on calibration between the user, the display 110, and the eye tracking subsystem 140. For example, viewing angle data may be converted to display coordinates. These display coordinates may identify specific content items based on such calibration data, the time, and details about the location of content items within the document 500 being viewed.

At block 615, physiological data may be received, for example, from the EEG system 300 as physiological data recorded over time. Various additional or different physiological data may be received.

The eye tracking data and/or the physiological data may be two examples of behavior data. Other types of behavior data may be collected. Behavior data may include the amount of time the content is being displayed or interacted with, the number of times the user views the content, whether the user requests an enlargement of the content, whether the user turns up the volume in audio when viewing content with audio, whether the user scrolls back to view the content after previously viewing the content, and/or whether the user comments on the content. Behavior data, for example, may include data collected through the user interface 115.

At block 620, a salience score may be determined from the eye tracking data, the physiological data, and/or the behavior data. For example, the eye tracking data may be used to show which content item is being viewed by the user while the physiological data is being recorded. As another example, the eye tracking data may be used in conjunction with the physiological data to provide information on the focus of the user. Regardless, the physiological data and/or eye tracking data may be converted or normalized into a salience score (and/or a focus score). Table 1, shown below, is an example of eye tracking data and salience scores associated with the content in the document 500.

TABLE 1

| Time | | Average |
|---|---|---|
| (seconds) | Content | Salience Score |
| 10 | Advertisement 505 | 40 |
| 10 | Image 515 | 45 |
| 25 | Video 520 | 56 |
| 145 | Image 515 | 70 |
| 75 | Text 510 | 82 |
| 10 | Advertisement 505 | 52 |
| 230 | Image 515 | 74 |
| 135 | Text 510 | 88 |
| 10 | Video 520 | 34 |

The first column of Table 1 is an example of an amount of time a user spent viewing content items listed in the second column before moving to the next content item. Note that the user moves between content items and views some content items multiple times. As shown, summing the amount of time the user spends viewing specific content items; the user views the advertisement 505 for a total of 20 seconds, the text 510 for a total of 210 seconds, the image 515 for a total of 385 seconds, and the video 520 for a total of 35 seconds. Thus, the user spends most of the time viewing the image 515. This data may be useful in describing how long the user is looking at the content, but does not reflect how interested, salient, or focused the user is when viewing the content in the document 500.

The third column lists the average salience score of the content. In this example, the salience score is normalized so that a salience score of one hundred represents high salience and/or focus and a salience score of zero represents little salience and/or focus. The salience score listed in Table 1 is the average salience score over the time the user was viewing the listed content item. The average salience score for both times the user viewed the advertisement 505 is 46, the average salience score for the text 510 is 85, the average salience score for the image 515 is 63, and the average salience score for the video 520 is 45. Thus, in this example, the text 510 has the highest salience even though the user viewed the text 510 for the second longest period of time, and the image 515 has the second highest salience score even though it was viewed the longest period of time.

At block 625, the content within the document may be associated with a salience score above a salience threshold may be sent to a social network service according to at least one embodiment described herein. The content, for example, may be automatically sent to the social network service without user interaction. For example, if the salience threshold is 75, then the text 510 from the document 500 may be sent to one or more social network services. As another example, if the salience threshold includes both the requirement that the salience score is greater than 65 and the content item was viewed for longer than 140 seconds, then the image 515 may be sent to the social network service. Any salience threshold and/or viewing time may be used. Moreover, salience scores and/or viewing time are two examples of rules that may be applied to content in order for the content to be sent to a social network service.

According to at least one embodiment described herein, any number or types of rules may be defined whereby content is sent to one or more social network services based on the user's behavioral and/or physiological response to the content.

According to at least one embodiment described herein, the content item may be sent to the social network service through a network connection. Alternatively, the content may be sent to an app (e.g., the Facebook® app), an application, or a web application (e.g., Windows Explorer) executing on a computing device. The app, the application, or the web application may then send the content item to the social network service.

According to at least one embodiment described herein, a social network service may be any platform, website, network location, or service that organizes and builds social network services or social relations among people who, for example, share interests, activities, backgrounds, virtual connections, or real-life connections. A social network service may include a representation of each user (often called a profile), his/her social links, and a variety of additional services. Most social network services are web-based and provide means for users to interact over the Internet, such as via e-mail, instant messaging, and posting content. Social network services may also include online communities. Social network services may allow users to share ideas, pictures, posts, activities, events, and interests with people in their network. Often a user shares content through a social network service by posting the content to a wall, news feed, stream, dashboard, etc. or by tweeting the content. Examples of social network services include Facebook®, Google+™, Twitter, Tumblr, Instagram, Orkut, etc., to name a few.

When a content item is sent to a social network service, the content item may be uploaded (or posted, tweeted, etc.) to the social network service and shared with other users of the social network service in accordance with the general practices and/or user practices of the social network service. Moreover, the user may choose settings at the social network service that instruct the social network service about how to share the content item with other users of the social network service.

According to at least one embodiment described herein, the user may be presented with a dialogue box that queries the user regarding whether the user would like to send the content item to the social network service. If the user provides a positive response to the query, the content item may be sent to the social network service. If the user provides a negative response to the query, the content item may not be sent to the social network service. Moreover, the dialogue box may allow the user to add additional content, such as, for example, a text comment to the content, prior to sending to the social network service.

As another example, the content item may be sent to one or more preselected social network services. As yet another example, the content item may be sent to a given social network service based on the type of content. For instance, the image 515, if it has a salience score above the salience threshold, may be sent to one social network service while the video 520, if it has a salience score above the salience threshold, may be sent to a different social network service.

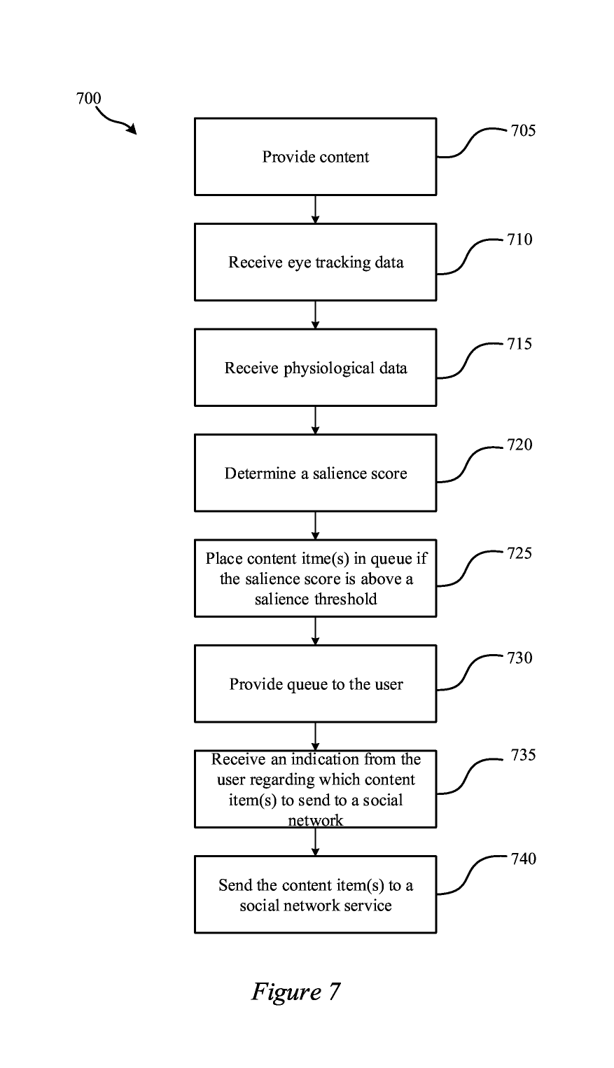

FIG. 7 is a flowchart of an example process 700 for queuing content prior to sending the content to a social network service according to at least one embodiment described herein. The process 700 may begin at block 705.

Block 705 may be similar to block 605 of FIG. 6. At block 705, the document 500 (or any content item) may be provided to a user, for example, through the display 110 and/or the user interface 115 as described above. At block 710, which may be similar to block 610 of FIG. 6, eye tracking data may be received from, for example, the eye tracking subsystem 140 as described above. At block 715, which may be similar to block 615 of FIG. 6, physiological data may be received as described above. At block 720, which may be similar to block 620 of FIG. 6, physiological data may be received as described above.

At block 725, the content within the document that is associated with a salience score above a salience threshold may be placed in a queue according to at least one embodiment described herein. For example, a description, name, title, link or pointer may be placed in the queue that references or points to the content. The queue, for example, may be maintained in the memory 120. By using salience scores, for example, the queue may be populated with content that the user may want to send to a social network service. For example, if the salience threshold is 75, then the text 510 from the document 500 may be placed in the queue. As another example, if the salience threshold includes both the requirement that the salience score is greater than 65 and the content item is viewed for longer than 140 seconds, then the image 515 may be placed in the queue.

According to at least one embodiment described herein, the queue may be limited to include only a set number of content items. The content items, for example, may be placed in the queue in order based on the salience score of each content item. Moreover, in the event a maximum number of content items has already been placed in the queue and another content item is sent to the queue, the content item with the lowest salience score may be removed from the queue to make room for the other content item in the queue.

At block 730, a listing of the content items within the queue may be provided to the user according to at least one embodiment described herein. For example, a listing of the content may be presented to the user through the display 110 and/or the user interface 115. The listing, for example, may include the name or title of the content, a link to the content, the actual content, a description of the content, the time the content was viewed, and/or where the content was consumed (e.g., the website, social network service, etc.), etc.

At block 735, an indication may be received from the user (e.g., through the user interface 115) regarding which content items in the listing of content items in the queue to send to a social network service. For example, the listing may also include a button that may be selected by the user to indicate the user's desire to send the content item to a social network service. As another example, the listing of content items in the queue may include multiple buttons that each correspond to a different social network service. The user may select one of the buttons to indicate the user's desire to send the content item to the associated social network service. The user may also be provided with a dialogue box that may allow the user to add content, such as a text comment, to the content item prior to sending to the social network service.

As another example, the queue may be provided to the user through a touch screen (e.g., on a smartphone or tablet) and the user may use a swipe or gesture to indicate the user's desire to send the content item to the social network service or to not send the content item to the social network service, as the case may be. As yet another example, the queue may be provided to the user via an e-mail, a reminder, a text message, or another service that indicates that the content items in the queue shall be sent to a social network service unless the user indicates otherwise.

At block 740 the content item(s) indicated by the user to be sent to a social network service may be sent to the social network service. Any additional content, such as a text comment, added by the user may also be sent to the social network service.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method of using salience to send a content item to a social network service, the method comprising:
providing a content item to a user through a user interface;
collecting physiological data of the user as the user interacts with the content item;
determining a salience score of the content item based at least in part on the physiological data; and
sending, in the event the salience score is greater than a salience threshold, the content item to a social network service.

2. The method according to claim 1, wherein the content item is automatically sent to the social network service, in the event the salience score is greater than the salience threshold.

3. The method according to claim 1, wherein the physiological data comprises physiological data corresponding to a physiological response of the user as the user interacts with the content item provided through the user interface.

4. The method according to claim 3, wherein the physiological data comprises data selected from a group consisting of EEG data, MRI data, and heart rate data.

5. The method according to claim 1, wherein the physiological data comprises eye tracking data corresponding to a plurality of viewing angles of an eye of a user over time as the user views at least a portion of the content item, wherein the salience score of the content item is based at least in part on the eye tracking data.

6. The method according to claim 1, wherein in the event the salience score is greater than the salience threshold, sending the content item to the social network service further comprises:
placing the content item in a queue;
providing a listing of content items in the queue to the user through the user interface;
receiving an indication through the user interface indicating a first content item in the listing of content items in the queue to send to the social network service; and
sending the first content item to the social network service.

7. A method comprising:
providing a content item to a user through a user interface;
collecting physiological data of the user as the user interacts with the content item; and
sending the content item to a social network service based on a result of a rule that is a function of the physiological data.

8. The method according to claim 7, wherein the physiological data comprises physiological data corresponding to a physiological response of the user as the user interacts with the content item provided through the user interface.

9. The method according to claim 7, wherein the rule determines whether to send the content item to the social network service based on a salience score of the content that is determined based on the physiological data.

10. The method according to claim 7, wherein the physiological data comprises eye tracking data corresponding to a plurality of viewing angles of an eye of a user over time as the user views at least a portion of the content item, wherein the salience score of the content item is based at least in part on the eye tracking data.

11. A non-transitory computer-readable medium having encoded therein programming code executable by a processor to perform operations comprising:
providing a content item to a user through a user interface;
collecting physiological data of the user as the user interacts with the content item;
determining a salience score of the content item based at least in part on the physiological data; and
in the event the salience score is greater than a salience threshold, sending the content item to a social network service.

12. The non-transitory computer-readable medium according to claim 11, wherein the physiological data comprises physiological data corresponding to a physiological response of the user as the user interacts with the content item provided through the user interface.

13. The non-transitory computer-readable medium according to claim 12, wherein the physiological data comprises data selected from a group consisting of EEG data, MRI data, and heart rate data.

14. The non-transitory computer-readable medium according to claim 11, wherein the physiological data comprises eye tracking data corresponding to a plurality of viewing angles of an eye of a user over time as the user views at least a portion of the content item, wherein the salience score of the content item is based at least in part on the eye tracking data.

15. The non-transitory computer-readable medium according to claim 11, wherein in the event the salience score is greater than the salience threshold, sending the content item to the social network service further comprises:
placing the content item in a queue;
providing a listing of content items in the queue to the user through the user interface;
receiving an indication through the user interface indicating a first content item in the listing of content items in the queue to send to the social network service; and
sending the first content item to the social network service.

16. A system of using salience to send a content item to a social network service, the system comprising:
a user interface for presenting a content item to a user;
a physiological sensor configured to record a physiological response of the user over time as the user views the content item via the user interface; and
a controller coupled with the user interface and the physiological sensor, the controller configured to:
provide the content item to the user through the user interface;
collect physiological data of the user as the user interacts with the content item;
determine a salience score of the content item based at least in part on the physiological data; and
send, in the event the salience score is greater than a salience threshold, the content item to a social network service.

17. The system according to claim 16, wherein the physiological data comprises physiological data corresponding to a physiological response of the user as the user interacts with the content item provided through the user interface.

18. The system according to claim 17, wherein the physiological data comprises data selected from a group consisting of EEG data, MRI data, and heart rate data.

19. The system according to claim 16, wherein the physiological data comprises eye tracking data corresponding to a plurality of viewing angles of an eye of a user over time as the user views at least a portion of the content item, wherein the salience score of the content item is based at least in part on the eye tracking data.

20. The system according to claim 16, wherein in the event the salience score is greater than the salience threshold, the controller is further configured to:
place the content item in a queue;
provide a listing of content items in the queue to the user through the user interface;
receive an indication through the user interface indicating a first content item in the listing of content items in the queue to send to the social network service; and
send the first content item to the social network service.
